(19) United States
(12) Patent Application Publication
(10) Pub. No.: US 2010/0133370 A1
(43) Pub. Date: Jun. 3, 2010

(54) KITCHEN WASTE DISPOSAL SYSTEM

(76) Inventor: William Flynn, County Cork (IE)

Correspondence Address: JACOBSON HOLMAN PLLC, 400 SEVENTH STREET N.W., SUITE 600, WASHINGTON, DC, 20004, US

(21) Appl. No.: 12/451,631

(22) PCT Filed: May 23, 2008
(86) PCT No.: PCT/IE2008/000060

§ 371 Date: Nov. 23, 2009

(30) Foreign Application Priority Data
May 23, 2007 (IE) 2007/0376

(51) Int. Cl. B02C 23/36

(52) U.S. Cl. 241/46.01

(57) ABSTRACT

A waste disposal system (1) fits under a conventional kitchen counter and has a drawer (3) for receiving waste from the user and being over a grinder (4), in turn over a liquidizer (6) for liquidizing ground waste and delivering it to a drain. The drawer (3) accommodates a sliding hopper (11). The grinder (4) comprises a pair of contra-rotating rotors (20) having series' of teeth (21) in a spiral pattern to draw the waste downwards and grind it to provide particulate waste that is gravity fed to the liquidizer (6). The liquidizer (6) comprises an auger (32) for moving the particles into a cylindrical housing (33) which has a water inlet (34) towards the rear. The housing (33) also houses a chopper blade (38) which rotates about the same axis as the cylinder (33) just below the water inlet (34). The chopper blade (38) is fed with a flow of particles by the auger (32), and injection of the water at the inlet (34) both assists the chopping or blending action and provides the water for the liquidized waste stream. The system is quick and convenient to operate as there is no need for chopping up the waste before inserting it into the drawer (3). Also, it is particularly safe because the hopper (11) completely blocks access to the space above the grinder (4).

### INTRODUCTION

1. Field of the Invention

The invention relates to disposal of kitchen organic waste.

2. Prior Art Discussion

It is known to provide a mechanism for disposing of kitchen waste by liquidising it at the sink and disposing of it through the waste water outlet. Typically, such an arrangement comprises an under-sink grinder with a rotating plate and grinding ring.

However, various practical problems arise. One is that the size of the opening is dictated by safety concerns, so that any item to be ground must first be chopped by hand to fit through the opening. For example, banana skins must firstly be chopped. Also, the grinder must be manually fed.

U.S. Pat. No. 7,025,882 and FR2668953 describe waste disposal systems, however they are quite complex, requiring functionality such as a compressed air supply.

The invention is therefore directed towards providing for improved disposal of kitchen waste, with improved user safety, and/or comprehensiveness of operation, and/or simplicity.

### SUMMARY OF THE INVENTION

According to the invention, there is provided a kitchen waste disposal system comprising:
a container for waste to be disposed,
a grinder for receiving waste from the container and grinding it to particles,
a liquidiser having a water inlet, an inlet from the grinder, a chopper to liquidise particulate waste and a drain for delivering liquidized waste; and
a drive mechanism for the grinder and the liquidiser.

In one embodiment, the container comprises a drawer movable between an open position for insertion of waste and a retracted position for feeding waste to the grinder.

In another embodiment, the drawer blocks access to the grinder when open.

In a further embodiment, the drawer comprises an aperture to allow waste to drop down into the grinder.

In one embodiment, the grinder is located underneath the aperture when the drawer is in the retracted position.

In another embodiment, the container further comprises a hopper which slides within the drawer, the hopper being open-bottomed, and being movable in the drawer between a front waste-receiving position and a rear waste disposal position.

In a further embodiment, the hopper is located over an aperture in the drawer at the waste disposal position.

In one embodiment, the hopper comprises a seal between a hopper lower rim and a base of the drawer, said seal being configured to automatically clean the base of the drawer upon movement for the hopper.

In another embodiment, the seal comprises a rubber skirt.

In a further embodiment, the drawer comprises a drive mechanism for moving the hopper between the waste insertion and disposal positions.

In one embodiment, the drawer comprises a drive mechanism for moving the drawer between the open and retracted positions.

In another embodiment, the system further comprises a metal detector mounted in or adjacent the container, and a controller, and means in the controller for generating an alert if metal is detected in the container.

In a further embodiment, the grinder comprises intermeshing teeth.

In one embodiment, the teeth are on contra-rotating rotors mounted to draw waste away from the container as it is being ground.

In another embodiment, the teeth extend in spiral patterns so that only a subset of the teeth in a series are in contact at any time.

In a further embodiment, the rotors comprise inter-meshing synchronization gears.

In one embodiment, said gears transfer drive from one rotor to the other.

In another embodiment, the drive mechanism is adapted to rotate the rotors at a speed in the range of 1500 rpm to 3000 rpm

In a further embodiment, the liquidizer comprises a sump and a chopper rotary blade for blending the waste particles.

In one embodiment, the water inlet is adjacent to the chopper blade.

In another embodiment, there are a plurality of chopper blades on a rotor driven by the drive mechanism.

In a further embodiment, the liquidiser further comprises an auger for feeding waste particles to the chopper blade.

In one embodiment, the liquidiser further comprises an auger for pumping waste particles to the chopper blade, and the auger is co-axial with the chopper blade rotor.

In another embodiment, the auger and the chopper are within the same cylindrical housing.

In a further embodiment, the liquidizer comprises a pump arranged to pump liquidized waste to a drain.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a rear perspective view of a kitchen waste disposal system of the invention;

FIGS. 2 and 3 are front and rear perspective views of a drawer for input of waste to the system;

FIG. 4 is a perspective view from the rear of the part of the system beneath the drawer, showing a grinder in more detail;

FIG. 5 is a rear perspective view of part of the system, showing a liquidizer in detail;

FIG. 6 is a perspective view showing an auger in more detail, FIG. 7(a) shows a chopper wheel and a pump rotor of the liquidizer, and FIG. 7(b) shows the chipper wheel in more detail; and

FIGS. 8 to 10 are cross-sectional diagrams showing construction and operation of the drawer in more detail.

### DESCRIPTION OF THE EMBODIMENTS

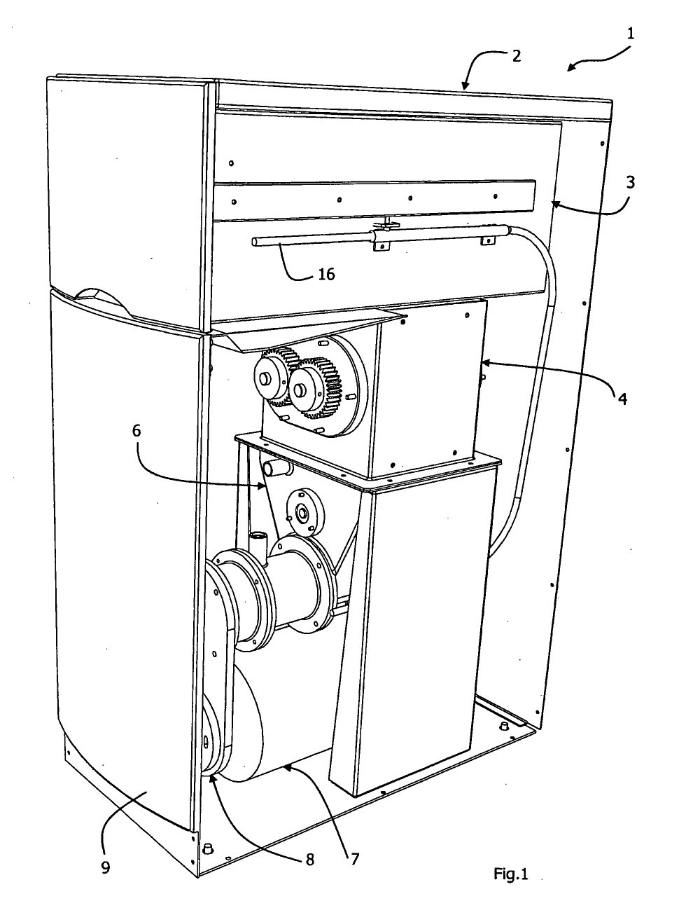

Referring to FIG. 1 a waste disposal system 1 comprises a housing 2 shaped to fit under a conventional kitchen counter. The system 1 comprises a drawer 3 in the upper portion of the housing for receiving waste from the user, and for feeding a grinding stage. The drawer 3 is over a grinder 4, in turn over a liquidizer 6 for liquidizing ground waste and delivering the liquidized waste to a drain. A motor 7 and a rear drive mechanism 8 are partially visible in FIG. 1. An electronic controller, not shown, is operatively connected to the drives for the various moving parts.

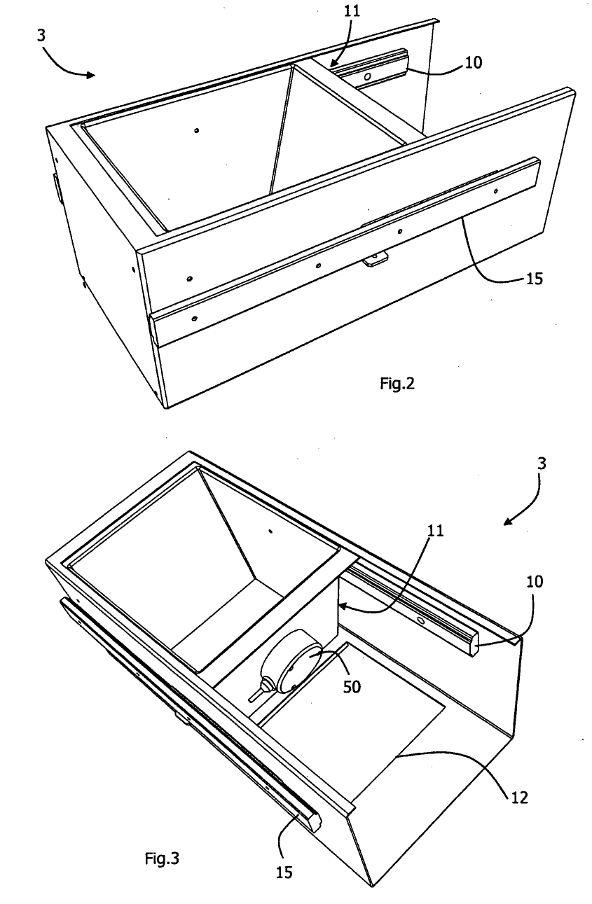

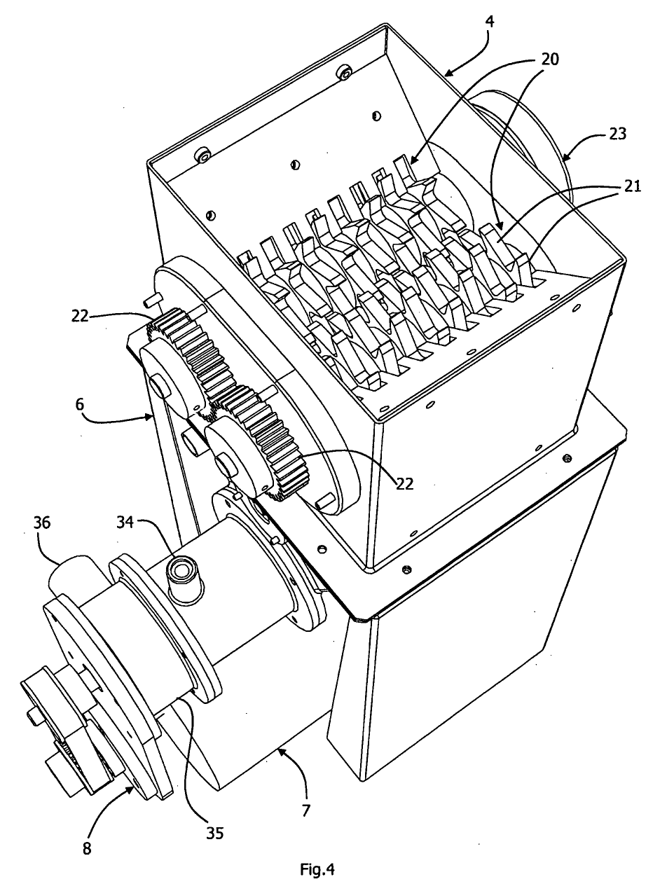

Referring also to FIGS. 2 and 3 the drawer 3 comprises internal rails 10 on which slides a bottomless hopper 11. The opening in the bottom of the hopper 11 corresponds in size with an aperture 12 in the floor of the drawer 3, towards the rear. The drawer 3 itself slides on external rails 15 for overall movement between its open and closed positions. FIG. 1 shows an electrically-driven piston mounded on the outside of the drawer 3. The piston 16 is connected to the hopper 11 through a slot, not shown, in the wall of the drawer 3 in order to slide the hopper within the drawer. A similar mechanism, not shown, is mounted on the housing 2 for movement of the drawer. It will be appreciated that any of a variety of mechanisms could be user for providing the sliding movement of the hopper 11 within the drawer 3 and of the drawer 3 within to the housing 2. Examples are pneumatic rams, hydraulic rams, or rack and pinion mechanisms. Also, they could be manually powered.

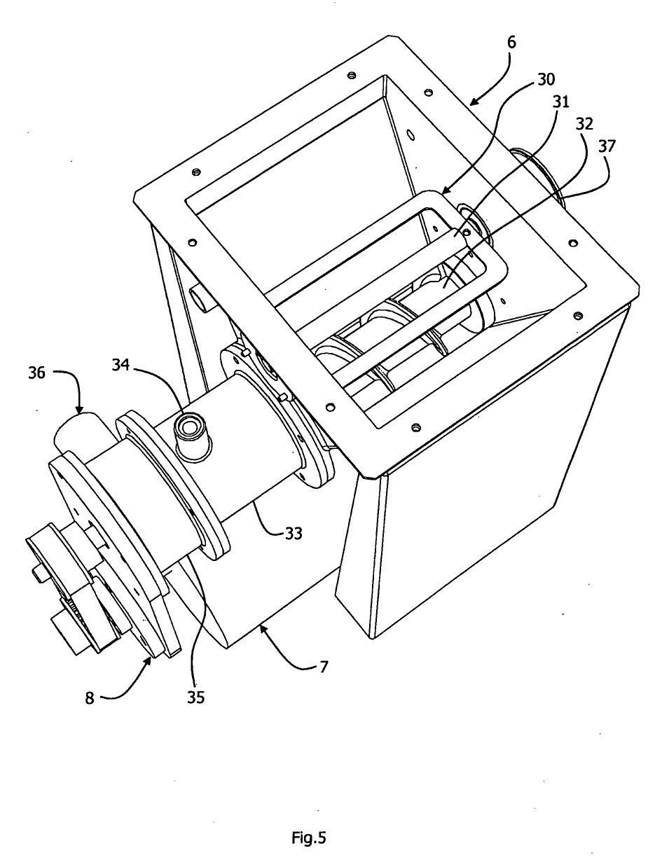

Referring to FIG. 4, the grinder 4 comprises a pair of contra-rotating rotors 20 having series' of teeth 21 in a spiral pattern. This arrangement of rotors 20 and teeth 21 operates to draw the waste downwards between the teeth, and because of the spiral pattern only two opposing teeth 21 are in contact at any time. The latter feature helps to avoid the grinder becoming clogged even with difficult waste items such as a chicken carcass, and also helps to minimise power consumption. One rotor 20 is belt-driven at the front by a belt 23, and outside the rear wall of the grinder 6 each rotor 20 terminates in a gear 22. The gears 22 are inter-meshed for the belt-driven rotor 20 to drive the other rotor 20, for synchronization of the rotors 20, and to ensure a positive drive without slippage.

The output of the grinder 4 is particulate waste, and this is gravity fed to the liquidizer 6.

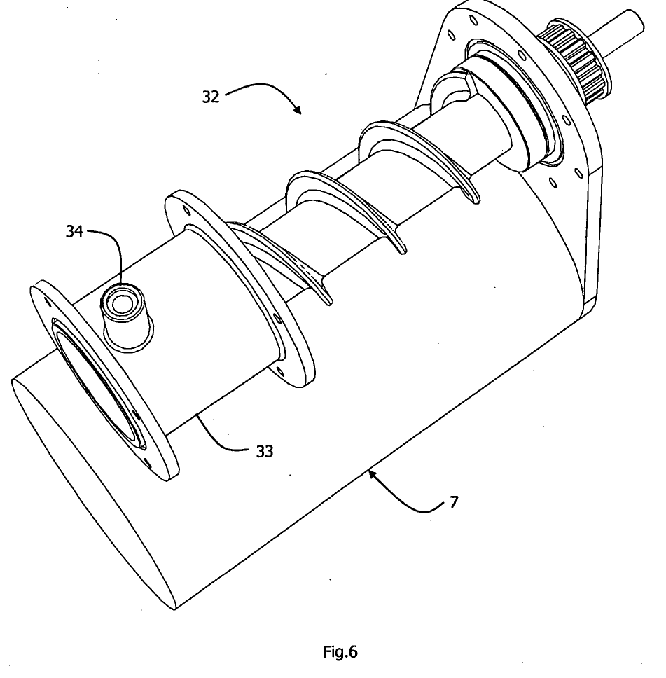

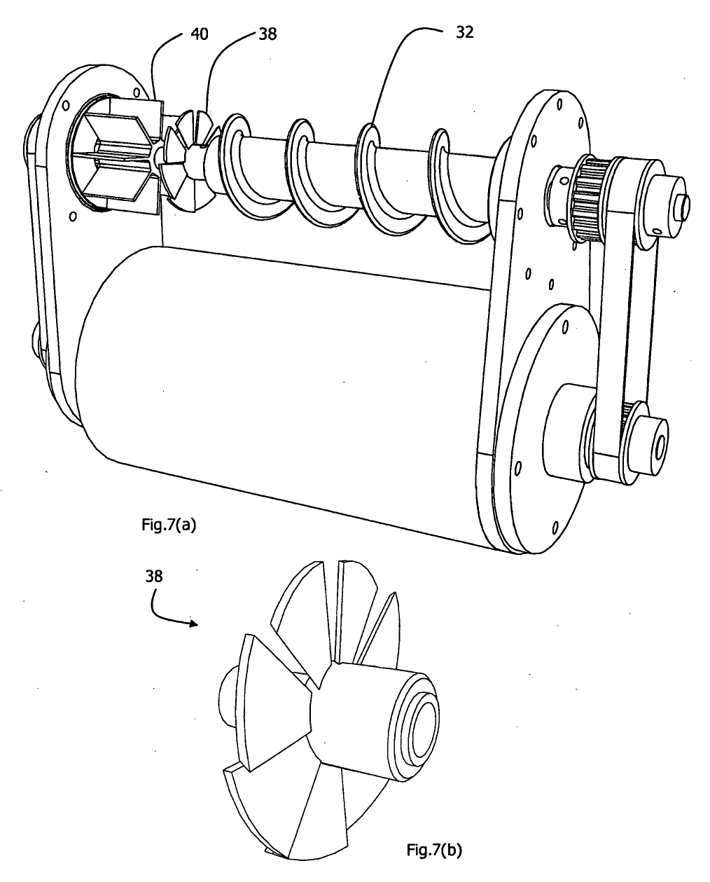

Referring to FIGS. 5 to 7, the liquidizer 6 comprises an agitator 30 having two longitudinal bars rotating about a drive shaft 31, also driven from the motor 7 by a belt 37. The rotational speed is 25 rpm, and is more generally is preferably in the range of 10 rpm to 40 rpm. The agitator 30 agitates the ground waste particles which drop from the grinder 4, facilitating their downstream movement.

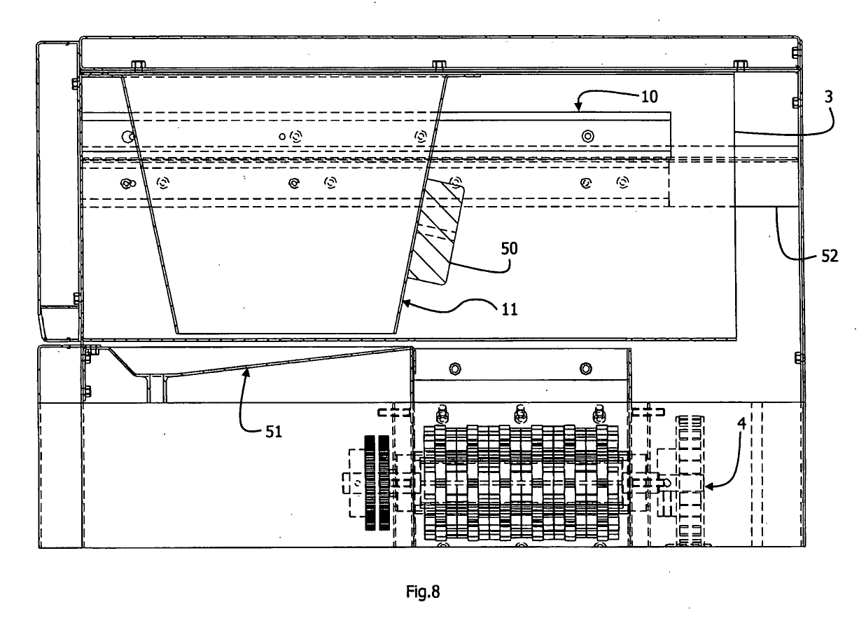

The liquidizer 6 also comprises an auger 32 for moving the waste particles towards the rear of the system 1. The auger 32 is driven at the same speed as the agitator 30, and by the same belt 37. Also, it has the same preferred range of rotational speeds as the auger. The auger 32 feeds the particles into a cylindrical housing 33 which has a water inlet 34 towards the rear. The housing 33 also houses a chopper blade 38 which rotates about the axis of the cylinder 33 and is mounted in the cylinder 33 just below the water inlet 34. The chopper blade 38 is shown in more detail in FIGS. 7(a), 7(b) and 8. It is driven by the rear drive mechanism 8 at a rotational speed of 2000 rpm, and more generally preferably in the range of 1500 rpm to 3000 rpm. The chopper blade 38 is fed with a consistent flow of particles by the auger 32, and injection of the water at the inlet 34 both assists the chopping or blending action and provides the water for the outlet liquidized waste stream.

A pump 35 with a rotor 40 pumps the liquidized waste stream to a drain outlet 36.

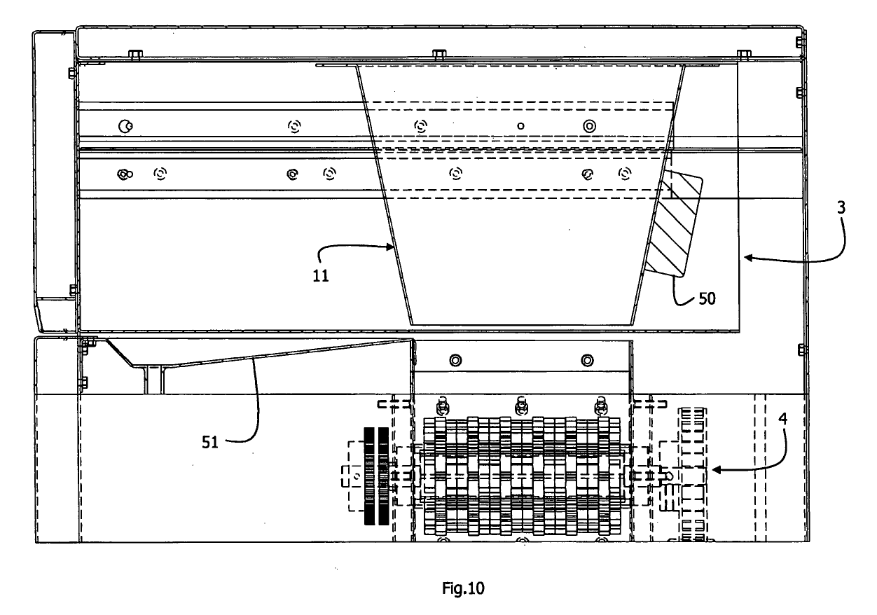

Referring to FIGS. 8 to 10, the drawer 3 also comprises a metal detector 50 operatively connected to the controller so that the system does not operate and generates a user alert if metal is detected in the drawer 3. These drawings also show a drip tray 51 for catching any drips which escape the rubber skirt seal around the bottom rim of the hopper 11. The seals help to automatically clean the base of the drawer upon sliding movement of the hopper 11. Also, these drawings show rails 52 on the inside of the housing 2 wall for engagement with the rails 15 on the drawer wall.

In operation, any cooked or uncooked kitchen organic waste may be directly inserted into the drawer 3 hopper 11. It is sized so that it can accommodate the waste from a full day in a typical domestic kitchen, or typically for shorter periods for a restaurant kitchen.

FIG. 8 show the drawer in its default retracted position.

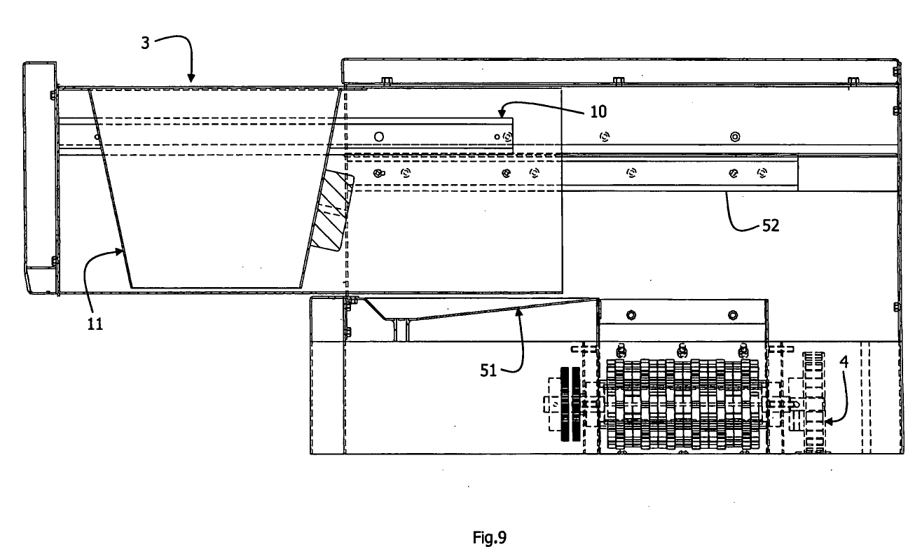

FIG. 9 shows the drawer 3 when ready for use, in position for placing waste into the hopper 11. The drawer 3 protrudes to the front and the hopper 11 is located to the front of the drawer 3. As is clear from this diagram, the kitchen waste may be easily placed on the hopper 11, and the hopper 11 blocks access to the grinder 5.

By pressing a button the controller causes the drawer 3 to slide to the retracted default position of FIG. 8. At some time either immediately or later, the user presses another button to activate waste processing. The controller in response causes the hopper 11 to slide to the rear of the drawer 3, in registry with the drawer aperture 12. The waste then simply falls into the grinder 4, the rotors 20 of which are activated to draw the waste down and to grind it to particles. The particles are driven by the auger 32 towards the chopper blade 38 where they are liquidized with injection of water at the inlet 34. The pump 35 delivers the liquidized waste to the drain outlet 36.

The system is quick and convenient to operate as there is no need for chopping up the waste before inserting it into the drawer 3. Another advantage is that the system is particularly safe, as the moving parts are only accessed via a maintenance door 9. There is excellent safety because the hopper 11 completely blocks access to the space above the grinder 4 and the drawer 3 front wall provides additional protection. Quality of the outlet waste stream is good and consistent because of uniform feeding of the particles to the chopping rotor.

The invention is not limited to the embodiments described but may be varied in construction and detail. The system may include a rinsing/washing system for the drawer, including the hopper. The rinsing/wasting system is preferably fed by a branch from the water supply to the inlet 34. It is also envisaged that the drawer and the hopper may be moved by a manually-operated mechanism such as spindles operated by a hand-wheel. The ground particles may be liquidized by a chopper blade which receives a direct feed from the grinder, such as a gravity feed. Also, with an appropriate configuration and power to the grinder, the liquidizing may involve only addition of water to a flow of very small particles from the grinder. It is also envisaged that the container comprises only a drawer without a hopper, but having a ram for pushing the waste out of the drawer for waste processing.

1-25. (canceled)

26. A kitchen waste disposal system comprising:
a container for waste to be disposed,
a grinder for receiving waste from the container and grinding it to particles,
a liquidiser comprising:
a water inlet,
an inlet from the grinder,
a chopper to liquidise particulate waste, and
a drain for delivering liquidized waste; and
a drive mechanism for the grinder and the liquidiser;
wherein the container comprises a drawer movable between an open position for insertion of waste and a retracted position for feeding waste to the grinder; and
wherein the drawer blocks access to the grinder when open.

27. The kitchen waste disposal system as claimed in claim 26, wherein the drawer comprises an aperture to allow waste to drop down into the grinder.

28. The kitchen waste disposal system as claimed in claim 27, wherein the grinder is located underneath the aperture when the drawer is in the retracted position.

29. The kitchen waste disposal system as claimed in claim 26, wherein the container further comprises a hopper which slides within the drawer, the hopper being open-bottomed, and being movable in the drawer between a front waste-receiving position and a rear waste disposal position.

30. The kitchen waste disposal system as claimed in claim 29, wherein the hopper is located over an aperture in the drawer at the waste disposal position.

31. A kitchen waste disposal system as claimed in claim 26, wherein the container further comprises a hopper which slides within the drawer, the hopper being open-bottomed, and being movable in the drawer between a front waste-receiving position and a rear waste disposal position; and wherein the hopper comprises a seal between a hopper lower rim and a base of the drawer, said seal being configured to automatically clean the base of the drawer upon movement for the hopper.

32. The kitchen waste disposal system as claimed in claim 31, wherein the seal comprises a rubber skirt.

33. The kitchen waste disposal system as claimed in claim 26, wherein the container further comprises a hopper which slides within the drawer, the hopper being open-bottomed, and being movable in the drawer between a front waste-receiving position and a rear waste disposal position; and wherein the drawer comprises a drive mechanism for moving the hopper between the waste insertion and disposal positions.

34. The kitchen waste disposal system as claimed in claim 26, wherein the drawer comprises a drive mechanism for moving the drawer between the open and retracted positions.

35. The kitchen waste disposal system as claimed in claim 26, wherein the system further comprises a metal detector mounted in or adjacent the container, and a controller, and means in the controller for generating an alert if metal is detected in the container.

36. The kitchen waste disposal system as claimed in claim 26, wherein the grinder comprises intermeshing teeth.

37. The kitchen waste disposal system as claimed in claim 26, wherein the grinder comprises intermeshing teeth; and wherein the teeth are on contra-rotating rotors mounted to draw waste away from the container as it is being ground.

38. The kitchen waste disposal system as claimed in claim 26, wherein the grinder comprises intermeshing teeth; and wherein the teeth extend in spiral patterns so that only a subset of the teeth in a series are in contact at any time.

39. The kitchen waste disposal system as claimed in claim 26, wherein the grinder comprises intermeshing teeth; and wherein the teeth are on contra-rotating rotors mounted to draw waste away from the container as it is being ground; and wherein the rotors comprise inter-meshing synchronization gears.

40. The kitchen waste disposal system as claimed in claim 26, wherein the grinder comprises intermeshing teeth; and wherein the teeth are on contra-rotating rotors mounted to draw waste away from the container as it is being ground; and wherein the rotors comprise inter-meshing synchronization gears; and wherein said gears transfer drive from one rotor to the other.

41. The kitchen waste disposal system as claimed in claim 26, wherein the grinder comprises intermeshing teeth; and wherein the teeth are on contra-rotating rotors mounted to draw waste away from the container as it is being ground; and wherein the drive mechanism is adapted to rotate the rotors at a speed in the range of 1500 rpm to 3000 rpm

42. The kitchen waste disposal system as claimed in claim 26, wherein the liquidizer comprises a sump and a chopper rotary blade for blending the waste particles.

43. The kitchen waste disposal system as claimed in claim 26, wherein the liquidizer comprises a sump and a chopper rotary blade for blending the waste particles; and wherein the water inlet is adjacent to the chopper blade.

44. The kitchen waste disposal system as claimed in claim 26, wherein the liquidizer comprises a sump and a chopper rotary blade for blending the waste particles; and wherein the water inlet is adjacent to the chopper blade; and wherein there are a plurality of chopper blades on a rotor driven by the drive mechanism.

45. The kitchen waste disposal system as claimed in claim 26, wherein the liquidizer comprises a sump and a chopper rotary blade for blending the waste particles; and wherein the water inlet is adjacent to the chopper blade; and wherein the liquidiser further comprises an auger for feeding waste particles to the chopper blade.

46. The kitchen waste disposal system as claimed in claim 26, wherein the liquidizer comprises a sump and a chopper rotary blade for blending the waste particles; and wherein the liquidiser further comprises an auger for pumping waste particles to the chopper blade, and the auger is co-axial with the chopper blade rotor.

47. The kitchen waste disposal system as claimed in claim 26, wherein the liquidizer comprises a sump and a chopper rotary blade for blending the waste particles; and wherein the liquidiser further comprises an auger for pumping waste particles to the chopper blade, and the auger is co-axial with the chopper blade rotor; and wherein the auger and the chopper are within the same cylindrical housing.

48. A kitchen waste disposal system as claimed in claim 26, wherein the liquidizer comprises a pump arranged to pump liquidized waste to a drain.
